(19) United States
(12) Patent Application Publication
(10) Pub. No.: US 2026/0067230 A1
(43) Pub. Date: Mar. 5, 2026

(54) SERVICE ORDER-PRESERVING GLOBAL FINISH TIME-BASED NETWORK LATENCY GUARANTEE SYSTEM AND METHOD

(71) Applicant: SANGMYUNG UNIVERSITY INDUSTRY-ACADEMY COOPERATION FOUNDATION, Seoul (KR)

(72) Inventor: Jinoo JOUNG, Seoul (KR)

(73) Assignee: SANGMYUNG UNIVERSITY INDUSTRY-ACADEMY COOPERATION FOUNDATION, Seoul (KR)

(21) Appl. No.: 19/107,029

(22) PCT Filed: Oct. 17, 2023
(86) PCT No.: PCT/KR2023/015975

§ 371 Date: Feb. 27, 2025

(30) Foreign Application Priority Data
Oct. 21, 2022 (KR) 10-2022-0136578
Feb. 23, 2023 (KR) 10-2023-0024451

(51) Int. Cl. H04L 47/62

(52) U.S. Cl. CPC H04L 47/62

(57) ABSTRACT

A network latency guarantee system includes a packet processing unit configured to generate new metadata by storing arrived packets and calculating finish times of stored packets, a scheduling unit configured to extract a packet having a minimum finish time by comparing the finish times of the stored packets, and a packet output unit configured to output scheduled packets through output ports.

### TECHNICAL FIELD

The present invention relates to service order-preserving global finish time-based network latency guarantee system and method, and more specifically, to a system and method for guaranteeing network latency to guarantee an upper limit of the network latency by deriving the finish time of a packet at a core node of a network without managing state information for each flow based on global finish time information generated at a first node and setting a schedule according thereto.

### BACKGROUND ART

A technology for guaranteeing latency by considering a flow, which is a collection of packets belonging to the same application, with the same source and destination, as a fluid and providing all flows with exactly the amount of requested service through appropriate scheduling at a relay node based thereon has been proposed since the 1990s. Latency guarantee and flow protection are closely related to each other. The degree of flow protection is inversely proportional to an upper limit of latency. There are three levels of flow protection technology.

The first level of the flow protection technology is a technology that limits interference between flows to a maximum level of packet size. When this technology is applied, the upper limit of latency at each node is proportional to a maximum packet length. However, the complexity of managing and recording a large number of state information for each flow is problematic, and accordingly, the first level of the flow protection technology is not actually applied.

The second level of the flow protection technology does not maintain detailed individual states reflecting the characteristics of flow, but instead records only the fixed requirements and service history of the flow and prescribes future services based thereon. When this technology is applied, the upper limit of the latency at each node is proportional to the sum of maximum packet sizes for each flow.

The third level of the flow protection technology stores flows in queues grouped by priority and simply services the queues by priority. When this technology is applied, the upper limit of the latency is determined by the sum of maximum burst sizes for each flow. The maximum burst size refers to the total amount of data that can be sent at once from an initial source, which is allowed for each flow. The maximum burst size generally represents the concept of an allowable group of a large number of packets. Therefore, it can be difficult to accept the upper limit of the latency proportional to the sum of the packets in some cases. Moreover, when there is a cycle in a network topology of the network to which these technology is applied, the maximum latency can be amplified while passing through nodes, and a situation can arise where the upper limit of the latency is not be guaranteed depending on network utilization levels.

Therefore, a method of applying the first-level technology with the best performance to the Internet has been studied. Generalized processor sharing (GPS) presented a paradigm for fair service for flow as a fluid, and packetized GPS (PGPS, or weighted fair queuing), which implemented this in a packet environment, played a pioneering role in this type of packet-based schedulers. These are collectively called a fair queuing scheduler. Fair queuing determines a service order of packets in ascending order of the finish time derived from Equation 1 below.

$$F ( p ) = max \{ F ( P - 1 ) , V ( A ( P ) ) \} + \frac{L ( p )}{r} \qquad [ Equation 1 ]$$

Here, p is the p^{th} packet of a flow, A(p) is the time when a packet p arrives at a node, L(p) is a length of p, and r is a service rate assigned to the flow to which p belongs. V(t) is called a virtual time function and can be calculated in various ways, such as multiplication of a real time t and a ratio of the sum of r of flows being serviced and the link capacity, or the current time. Virtual time prevents an unfair situation in which, in a state where the flow is serviced at a faster speed than the assigned speed, flows starting late have relatively small finish times, and thereby, priority service is provided for a considerable period of time over existing flows. F(p) represents the fairly calculated finish time of p, and the nodes receive service in order of the smallest value. The finish time can be calculated at the moment when the packet arrives at a node, and accordingly, it can be recorded and used in the node as metadata of the packet before being stored in the buffer. In general, a queue is provided for each flow, and the queue is managed as a FIFO or PIFO, and a scheduler is implemented in a form in which the head of queue (HoQ) for each flow is checked and the queue having the shortest finish time is serviced.

Alternatively, it is possible to put all packets in one queue and insert the packets in the middle of the queue according to a finish time value. The finish time is an expected finish time when the packet is fairly serviced. The key of Equation 1 is that, in a worst case, that is, when all flows are activated and the link is fully utilized, the service is provided at an interval of L(p)/r compared to the previous packet belonging to the flow. At the same time, by using a work-preserving scheduler, it is possible to prevent link resources from being unused and wasted.

In order to calculate Equation 1, F(p-1) of a flow, that is, the finish time of the previous packet has to be remembered. When a packet is received, the packet has to be found out which flow the packet belongs to and the finish time of the most recent packet of the corresponding flow has to be found out. The finish time F(p-1) of the recent packet is a value representing the so-called ‘flow state’. The fact that the state information has to be remembered and read means considerable complexity for a core node managing millions of flows, and this has become the main reason why the fair queuing scheduler is not actually used on the Internet. It is impossible to manage millions of flow states in real time in the core node.

To solve this problem, a method has been proposed in which a flow state can be derived at a core node by using only a packet state by allowing the necessary information to be written at a first node and modify the necessary information without managing the state information of the flow at the core node.

However, previous studies have attempted to reflect the time information required for the service of packets at the finish time at each node, which implies the possibility that a service order of packets of different sizes in the same flow can be reversed.

To prevent this, the concept of the eligible time of a packet service is introduced to guarantee a service order between packets. Accordingly, the packet operates in a non-work preserving manner. This can guarantee an upper limit of the latency, but there is a disadvantage that an average latency increases significantly, and accordingly, a solution for this is needed.

Meanwhile, a method of recording such packet-related information in a packet header and modifying the information at each node has not been accepted as an Internet standard due to complexity thereof.

### DISCLOSURE

### Technical Problem

Technical object to be achieved by the present invention is to provide a system and method for guaranteeing network latency to guarantee an upper limit of the network latency by deriving the finish time of a packet at a core node of a network without managing state information for each flow based on global finish time information generated at a first node and setting a schedule according thereto.

### Technical Solution

According to an embodiment of the present invention, a network latency guarantee system based on service order-preserving global finish time includes a packet processing unit configured to generate new metadata by storing arrived packets and calculating finish times of stored packets, a scheduling unit configured to extract a packet having a minimum finish time by comparing the finish times of the stored packets, and a packet output unit configured to output scheduled packets through output ports.

The scheduling unit can extract a packet having a minimum finish time by storing multiple flow sets classified according to a predefined criteria in separate FIFO (first in, first out) queues and by comparing finish times of heads (Head of Queue, HoQ) of the multiple FIFO queues to each other.

Here, in the predefined criteria, at least one of a maximum burst size, a maximum packet size, and an assigned service rate can be used for the classification of similar flows within a preset error range.

The scheduling unit can extract the packet having the minimum finish time by using a priority queue.

The packet processing unit can apply a fair queuing method to calculate a finish time of a first node by applying an equation below.

$${F}_{0} ( p ) = max \{ {F}_{0} ( p - 1 ) , {A}_{0} ( p ) \} + L ( p ) / r .$$

Here, F₀(p) is a finish time calculated at a time when a packet p is entered into a first node 0, A₀(p) represents a real time or a virtual time at a time when the packet p is entered into the first node 0, L(p) represents a length of the packet p, and r means a service rate assigned to a flow to which the packet p belongs.

The packet processing unit can calculate a finish time (F₀(p)) at a core node h by using an equation below.

$${F}_{h} ( p ) = {F}_{h - 1} ( p ) + {d}_{h} ( p )$$

Here, dₕ(p) represents a function of a core node h and a packet and is defined as an increment of a finish time calculated from the core node h, the core node h and a core node h-1 mean nodes through which a packet p passes, and the packet p passes through the core node h immediately after passing through the core node h-1.

Also, dₕ(p) can be determined according to a rule defined between Wₕ₋₁(p) and Uₕ₋₁(p), Wₕ₋₁(p) represents a low limit of a latency of the packet p at the core node h-1, and Uₕ₋₁(p) represents a maximum latency that the packet p is able to experience at the core node h-1.

Also, dₕ(p) can be determined according to an equation below.

$${d}_{h} ( p ) = \frac{{L}_{h - 1}^{max}}{{R}_{h - 1}} + {L}_{i} / {r}_{i}$$

Here,

$${L}_{h - 1}^{max}$$

represents a maximum packet length for all flows in the core node h-1, Rₕ₋₁ represents a link capacity in the core node h-1, Li represents a maximum packet length of a flow i, and ri represents a service rate assigned to the flow i, to which the packet p belongs.

Meanwhile, dₕ(p) can be determined according to a rule defined between Wₕ₋₁(p) and Uₕ₋₁(p), Wₕ₋₁ represents a low limit of a latency of any packet in the core node h-1, and Uₕ₋₁ represents a maximum latency that any packet is able to experience in the core node h-1.

According to another embodiment of the present invention, a network latency guarantee method using a network latency guarantee system includes a step of storing arrived packets, a step of generating new metadata of the arrived packets by calculating finish times (FT) of the packets, a step of extracting a packet having a minimum finish time by comparing the finish times of the stored packets to each other, and a step of outputting scheduled packets through an output port.

### Advantageous Effects

In this way, according to the present invention, the finish time derived from the first node is recorded in a packet as metadata, and based thereon, the finish time can be updated in a simple way in downstream nodes without managing state information for each flow, and thereby, a packet schedule order can be determined. Accordingly, an upper limit of the network latency can be guaranteed without managing the flow state information.

In addition, according to the present invention, there is characteristic in which a scheduler proceeds by adding only the node-specific state information to the finish time at the first node, and thus, a service order of packets of all flows passing through the same path can be unaltered, and there is an advantage in that a packet having the minimum finish time can be easily found out by comparing only HoQs of multiple FIFO queues or by using a priority queue.

### DESCRIPTION OF DRAWINGS

FIG. 1 is a configuration diagram illustrating a network latency guaranteeing system according to an embodiment of the present invention.

FIG. 2 is a flowchart illustrating a network latency guaranteeing method using a network latency guaranteeing system, according to an embodiment of the present invention.

FIG. 3 is a diagram illustrating an implementation example for being described with reference to FIG. 2.

FIG. 4 is a diagram illustrating a network topology for performance comparison.

FIG. 5 is a three-dimensional (3D) surface diagram for maximum end-to-end latency of a flow of type C according to dₕ and a utilization rate.

### DESCRIPTION OF SYMBOLS

100: latency guaranteeing system
110: packet processing unit
120: scheduling unit
130: packet output unit

### BEST MODE FOR INVENTION

Hereinafter, embodiments of the present disclosure will be described in detail with reference to the attached drawings such that those skilled in the art can easily implement the present disclosure. However, the present disclosure can be implemented in various different forms and is not limited to the embodiments described herein. In addition, in order to clearly describe the present disclosure with reference to the drawings, parts that are not related to the description are omitted, and similar parts are given similar reference numerals throughout the specification.

Throughout the specification, when a part is said to “include” a certain component, this does not mean that other components are excluded, but rather that other components can be further included, unless otherwise specifically stated.

Then, embodiments of the present disclosure will be described in detail with reference to the attached drawings such that those skilled in the art can easily implement the present disclosure.

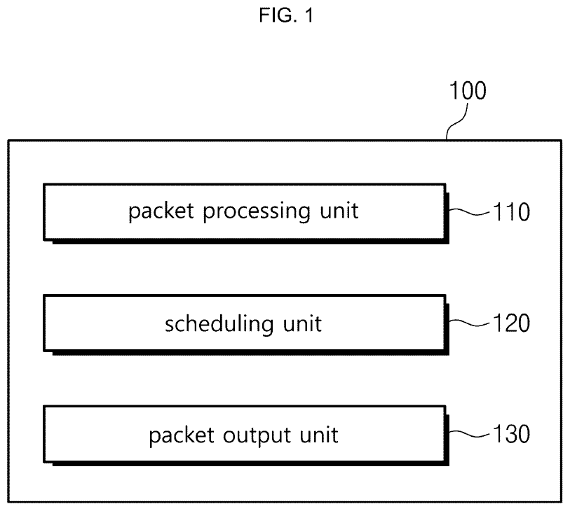

Hereinafter, a latency guarantee system according to an embodiment of the present invention will be described in more detail with reference to FIG. 1.

FIG. 1 is a configuration diagram illustrating a network latency guaranteeing system according to an embodiment of the present invention.

As illustrated in FIG. 1, a network latency guaranteeing system 100 according to an embodiment of the present invention includes a packet processing unit 110, a scheduling unit 120, and a packet output unit 130.

First, the packet processing unit 110 stores an arrived packet, calculates a finish time (FT) of the stored packet, and generates new metadata. The packet processing unit 110 then stores the generated metadata in a header of the packet.

The scheduling unit 120 compares the finish times of the stored packets to extract a packet with a minimum finish time. The scheduling unit 120 adjusts an output order of packets by using the priority information of packet traffic and the minimum finish time.

Here, the scheduling unit 120 can store a plurality of flow sets classified according to the predefined criteria in separate first-in-first-out (FIFO) queues, and compare finish times of the heads of the FIFO queues (head of Queue (HoQ)) to extract a packet having a minimum finish time. In this case, the predefined criteria can be to classify flows in which at least one of a maximum burst size, a maximum packet size, and an assigned service rate is within a predefined error range.

Alternatively, the scheduling unit 120 can extract a packet having the minimum finish time by using a priority queue.

Finally, the packet output unit 130 can output the scheduled packets through an output port.

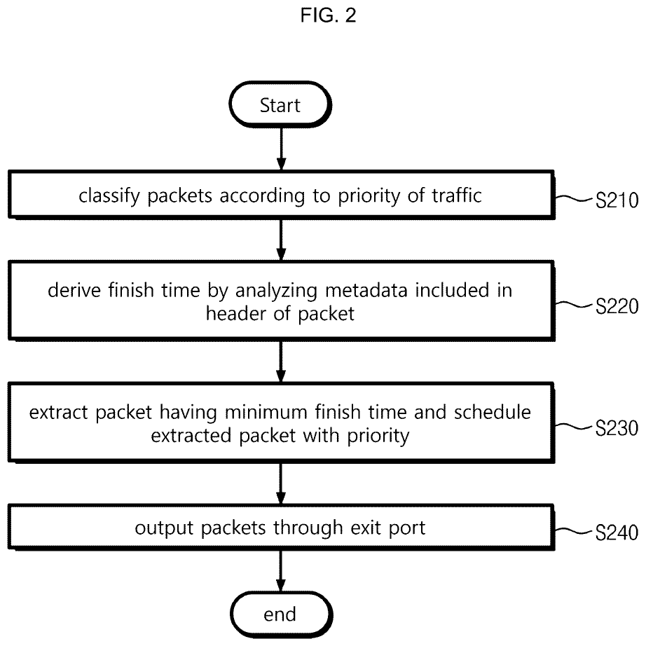

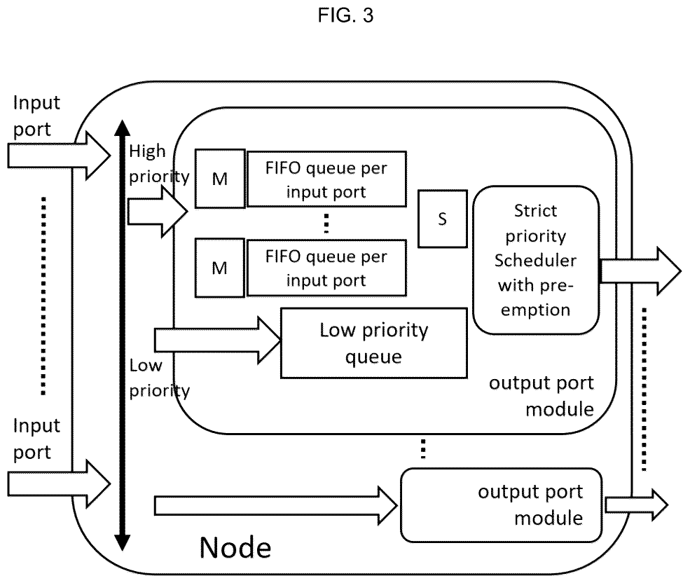

Hereinafter, a latency guarantee method using a latency guarantee system, according to an embodiment of the present invention, will be described in more detail with reference to FIG. 2 and FIG. 3.

FIG. 2 is a flowchart illustrating a network latency guarantee method using a network latency guarantee system, according to an embodiment of the present invention, and FIG. 3 is a diagram illustrating an implementation example for being described with reference to FIG. 2.

As illustrated in FIG. 2 and FIG. 3, the packet processing unit 110 classifies incoming packets according to the priority of a traffic (S210).

The packet processing unit 110 classifies all traffics into a high-priority traffic and a low-priority traffic, and classifies packets into a packet with the high priority traffic and a packet with the low-priority traffic.

Then, the packet processing unit 110 derives a finish time based on the metadata included in a header of the packet (S220).

Instead of deriving a new finish time for each node, the network latency guarantee system 100 according to an embodiment of the present invention derives a finish time in a downstream node by using the finish time information derived from a first node.

Therefore, the packet processing unit 110 derives a finish time of the current node by using the finish time of the previous node included in the metadata and a function of the packet.

To describe this again, the packet processing unit 110 calculates a finish time of a first node by applying a fair queuing method as represented by Equation 2 below.

$${F}_{0} ( p ) = max \{ {F}_{0} ( p - 1 ) , {A}_{0} ( p ) \} + L ( p ) / r . \qquad [ Equation 2 ]$$

Here, F₀(p) is a finish time calculated at the time when a packet p is entered into a first node 0, A₀(p) represents a real time or virtual time at the time when the packet p is entered into the first node 0, L(p) represents a length of the packet p, and r means a service rate assigned to a flow to which the packet p belongs.

Meanwhile, in the embodiments of the present invention, the finish time calculated at the first node is called a global finish time.

In addition, the packet processing unit 110 calculates the finish time Fₕ(p) at a core node h through Equation 3 below.

$${F}_{h} ( p ) = {F}_{h - 1} ( p ) + {d}_{h} ( p ) \qquad [ Equation 3 ]$$

Here, dₕ(p) represents a function of the core node h and a packet, and can be defined as an increment of the finish time calculated from the core node h. The core node h and a core node h-1 mean nodes through which the packet p passes, and the packet p passes through the core node h immediately after passing through the core node h-1. Meanwhile, dₕ(p) has to be a non-decreasing function between adjacent packets, which is to prevent service orders between adjacent packets from changing. According to an embodiment, a value of dₕ(p) can be implemented by a maximum latency measured from the start of the node's busy period to an incoming time of packet p.

Only values of Fₕ₋₁(p) and dₕ(p) are required when calculating the finish time at the core node h by using Equation 2 and Equation 3 above, and accordingly, there is no need to store and manage state information for each flow at the core node. Information for deriving Fₕ₋₁(p) and dₕ(p) can be stored in the form of metadata in the header of the packet to be transmitted. Although updates are required at all nodes, update is allowed at an appropriate time between the arrival time and the departure time of the packet, and accordingly, sufficient time is given.

In addition, according to an embodiment, dₕ(p) is determined according to a rule defined between Wₕ₋₁(p) and Uₕ₋₁(p), and Wₕ₋₁(p) represents a low limit of the latency of the packet p at the core node h-1, and Uₕ₋₁(p) represents a maximum latency that the packet p can experience at the core node h-1.

The core node h-1 is a node that the packet p passes through just before reaching the node h.

According to an embodiment, dₕ(p) is determined according to Equation 4 below.

$${d}_{h} ( p ) = \frac{{L}_{h - 1}^{max}}{{R}_{h - 1}} + {L}_{i} / {r}_{i} \qquad [ Equation 4 ]$$

Here,

$${L}_{h - 1}^{max}$$

represents a maximum packet length for all flows in the core node h-1, and Rₕ₋₁ represents a link capacity in the core node h-1. In addition, Li represents a maximum packet length of a flow i, and ri represents a service rate assigned to the flow i.

According to another embodiment, dₕ(p) is determined according to a rule defined between Wₕ₋₁(p) and Uₕ₋₁(p), Wₕ₋₁ represents a low limit of the latency of any packet in the core node h-1, and Uₕ₋₁ represents a maximum latency that any packet can experience in the core node h-1.

The finish time calculated according to the above description is calculated without increasing by

$$\frac{L ( p )}{r}$$

for each node when compared to Equation 2. This reflects the fact that it is fair to assume the entire network as one node and maintain an initial distance set between packets.

According to the embodiments of the present invention described above, a service order between the packets in the same path can be minimized from changing in the middle of the path. In addition, the finish time-based scheduling that required the general complex sorting algorithm can be easily implemented by comparing only the HoQs of multiple FIFO queues or by using a priority queue to find the packet with the minimum finish time among all stored packets. The scalability in a core node can be obtained with a configuration of a simple scheduler.

Meanwhile, dₕ(p) can be determined as Uₕ₋₁, and the finish time Fₕ(p) can affect the fairness between flows which arrive at the core node through different paths according to the value of dₕ. Therefore, in order to resolve this,

$${F}_{0} ( p ) \geq V ( {A}_{0} ( p ) ) + \frac{L ( p )}{r}$$

has to be satisfied. That is, the fairness between flows is guaranteed by linking the finish time F of the flows to a virtual time t.

In an embodiment of the present invention, dₕ(p) has to be equal to an upper limit of the latency Uₕ₋₁(p) guaranteed for the packet p at the node h-1. That is, the upper limit of the latency satisfies Equation 5 below.

$${A}_{h} ( p ) + {U}_{h} ( p ) \geq {A}_{h + 1} ( p ) \qquad Equation 5$$

As described above, when the calculation of the finish time is finished, the packet processing unit 110 stores the calculated finish time in the header of the packet in the form of metadata.

When step S220 is finished, the scheduling unit 120 extracts a packet having the minimum finish time by using the finish time stored in the header of the packet, and schedules the extracted packet with priority (S230).

That is, the scheduling unit 120 adjusts an output order of the packets by using the priority information of the packet traffic and the minimum finish time.

Finally, the packet output unit 130 adjusts an interval between the transmitted packets and outputs the packets through an output port (S240).

That is, the packet output unit 130 receives the packets output from the scheduler queue according to the scheduling result in the scheduling unit 120 and outputs the packets to the output port.

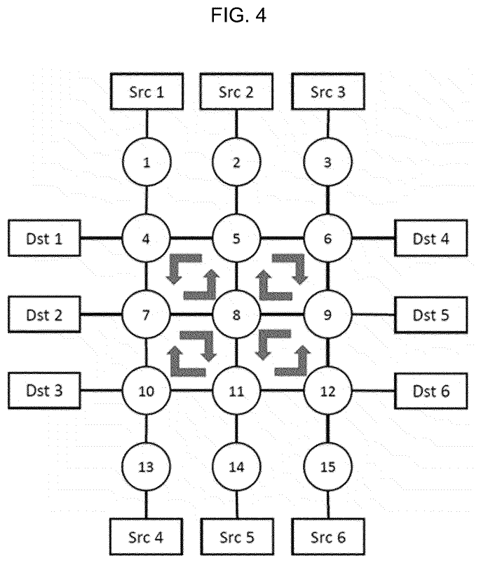

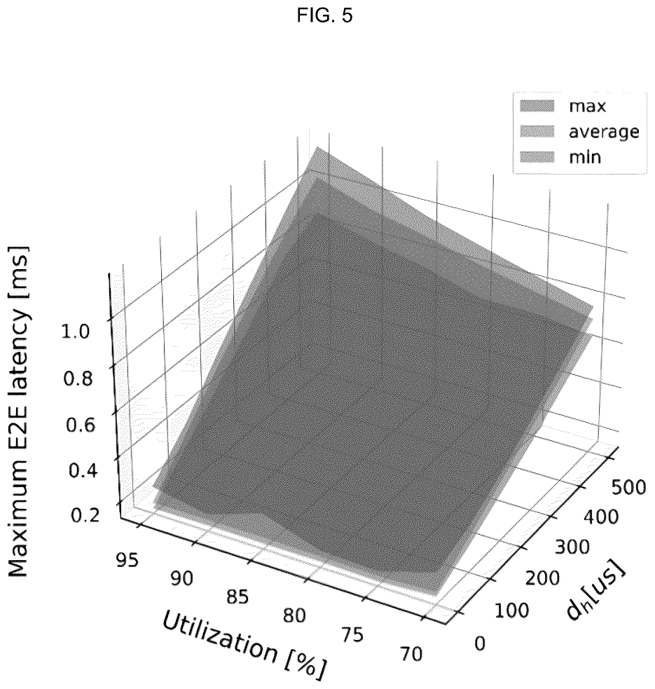

Hereinafter, performance comparison results of the network latency guarantee system according to the present invention will be described in more detail with reference to FIG. 4 and FIG. 5.

FIG. 4 is a diagram illustrating a network topology for performance comparison, and FIG. 5 is a three-dimensional surface map of the maximum end-to-end latency of a flow of a type C according to dₕ and a utilization.

First, as illustrated in FIG. 4, nodes 1, 2, 3, 13, 14, and 15 are entrance nodes directly connected to sources, and the other nodes are core nodes. Because output ports of the core nodes include queues for each input port, the output ports include two queues. Such queues operate on a PIFO basis unless otherwise specified. Packets are sorted according to finish time thereof when being added to the queues. The entrance node maintains a state of each flow and the FIFO queue of each flow. The link capacity of all links in a topology is 1 Gbps. In FIG. 4, arrows indicate flow directions.

The source generates one flow for each destination, and accordingly, 36 flows are generated for all networks. Table 1 and table 2 below show characteristics of the three different flow types used for simulation. The flow type is determined by the destination of flow. For example, all flows directing to node 1 are type A. Each destination has 6 flows, and each type has 12 flows. Here, the flow type can be classified according to at least one of a maximum burst size, a maximum packet size, and an assigned service rate. Specifically, at least one of the maximum burst size, the maximum packet size, and the assigned service rate can be classified among the same flows within a preset error range. The flow generates packets of various lengths from 1 Kbit to 10 Kbit in units of 1 Kbit.

TABLE 1

| Flow type | Maximum burst size | Packet size | Destination |
|---|---|---|---|
| A | 200 Kbit | 1K-10 Kbit | 1, 6 |
| B | 200 Kbit | 1K-10 Kbit | 3, 4 |
| C | 20 Kbit | 1K, 2 Kbit | 2, 5 |

TABLE 2

| | Peak input speed (Mbps) | | |
|---|---|---|---|
| Utilization | A | B | C |
| 70% | 9.857 | 98.571 | 98.571 |
| 75% | 10.571 | 105.714 | 105.714 |
| 80% | 11.262 | 112.619 | 112.619 |
| 85% | 11.976 | 119.762 | 119.762 |
| 90% | 12.667 | 126.667 | 126.667 |
| 95% | 13.381 | 133.81 | 133.81 |

The maximum end-to-end latencies observed from each flow type are compared to each other. A flow having the longest path within the same flow type is of interest. Table 3 shows a flow path having the longest path for each flow type. The number of hops for the longest path is the same for all flow types. The utilization of each path can change depending on links.

TABLE 3

| Flow type | Longest path |
|---|---|
| A | Src5-14-11-10-7-8-5-4-Dst1 |
| | Src2-2-5-6-9-8-11-12-Dst6 |
| B | Src5-14-11-10-7-8-5-6-Dst4 |
| | Src2-2-5-6-9-8-11-10-Dst3 |
| C | Src3-3-6-9-8-5-4-7-Dst2 |
| | Src6-15-12-9-8-5-4-7-Dst2 |
| | Src1-1-4-7-8-11-12-9-Dst5 |
| | Src4-13-19-7-8-11-12-9-Dst5 |

In this simulation, dₕ is the same for all nodes. In FIG. 6, respective planes represent a maximum value, an average value, and a minimum value of the observed maximum end-to-end latency. When dₕ increases, the maximum end-to-end latency also increases. This is because a flow having the largest number of hops among flows of the same type determines the maximum end-to-end latency. Because dₕ is a fixed value, finish times of packets having more hops increase, resulting in more latency regardless of the path. Also, this effect can be observed between different types of flows. When a utilization increases, the symptom is observed more clearly as dₕ increases.

When dₕ is 0, that is, dₕ is a minimum value, the packet generated first is advantageous. The finish time of a packet moving more hops is advantageous compared to a packet moving fewer hops.

In this way, the latency guarantee system according to the present invention records the finish time, which is derived from the first node, in a packet as metadata, and based thereon, the finish time can be updated in a simple way in lower nodes without managing state information for each flow, and thereby, a packet schedule order can be determined.

In addition, the latency guarantee system according to the present invention has the characteristic in which a scheduler proceeds by adding only the node-specific state information to the finish time at the first node, and thus, a service order of packets of all flows passing through the same path can be unaltered, and a packet having the minimum finish time can be easily found out by comparing only HoQs of multiple FIFO queues or by using a priority queue.

The present invention is described with reference to the embodiments illustrated in the drawings, but the embodiments are merely examples, and those skilled in the art will understand that various modifications and equivalent other embodiments can be derived therefrom. Therefore, the true technical protection scope of the present invention should be determined by the technical idea of the appended patent claims.

1. A network latency guarantee system based on service order-preserving global finish time, the network latency guarantee system comprising:
a packet processing unit configured to generate new metadata by storing arrived packets and calculating finish times of stored packets;
a scheduling unit configured to extract a packet having a minimum finish time by comparing the finish times of the stored packets; and
a packet output unit configured to output scheduled packets through output ports.

2. The network latency guarantee system of claim 1, wherein
the scheduling unit extracts a packet having a minimum finish time by storing multiple flow sets classified according to a predefined criteria in separate FIFO (first in, first out) queues and by comparing finish times of heads (Head of Queue, HoQ) of the multiple FIFO queues to each other.

3. The network latency guarantee system of claim 2, wherein,
in the predefined criteria, at least one of a maximum burst size, a maximum packet size, and an assigned service rate is classified for identical flows within a preset error range.

4. The network latency guarantee system of claim 1, wherein
the scheduling unit extracts the packet having the minimum finish time by using a priority queue.

5. The network latency guarantee system of claim 1, wherein
the packet processing unit applies a fair queuing method to calculate a finish time of a first node applying an equation below:
$${F}_{0} ( p ) = max \{ {F}_{0} ( p - 1 ) , {A}_{0} ( p ) \} + L ( p ) / r .$$
where, F₀(p) is a finish time calculated at a time when a packet p is entered into a first node 0, A₀(p) represents a real time or a virtual time at a time when the packet p is entered into the first node 0, L(p) represents a length of the packet p, and r means a service rate assigned to a flow to which the packet p belongs.

6. The network latency guarantee system of claim 1, wherein
the packet processing unit calculates a finish time (Fₕ(p)) at a core node h by using an equation below:
$${F}_{h} ( p ) = {F}_{h - 1} ( p ) + {d}_{h} ( p )$$
where, dₕ(p) represents a function of a core node h and a packet and is defined as an increment of a finish time calculated from the core node h, the core node h and a core node h-1 mean nodes through which a packet p passes, and the packet p passes through the core node h immediately after passing through the core node h-1.

7. The network latency guarantee system of claim 6, wherein
dₕ(p) is determined according to a rule defined between the values Wₕ₋₁(p) and Uₕ₋₁(p), Wₕ₋₁(p) represents a minimum latency of the packet p at the core node h-1, and Uₕ₋₁ (p) represents a maximum latency that the packet p is able to experience at the core node h-1.

8. The network latency guarantee system of claim 7, wherein
dₕ(p) is determined according to an equation below:
$${d}_{h} ( p ) = \frac{{L}_{h - 1}^{max}}{{R}_{h - 1}} + {L}_{i} / {r}_{i}$$
where,
$${L}_{h - 1}^{max}$$
represents a maximum packet length for all flows in the core node h-1, Rₕ₋₁ represents a link capacity in the core node h-1, Li represents a maximum packet length of a flow i, and ri represents a service rate assigned to the flow i, to which the packet p belongs.

9. The network latency guarantee system of claim 6, wherein
dₕ(p) is determined according to a rule defined between the values Wₕ₋₁ and Uₕ₋₁, Wₕ₋₁ represents a minimum latency of any packet in the core node h-1, and Uₕ₋₁ represents a maximum latency that any packet is able to experience in the core node h-1.

10. A network latency guarantee method using a network latency guarantee system, the network latency guarantee method comprising:
a step of generating new metadata by storing arrived packets and calculating finish times (FT) of the stored packets;
a step of extracting a packet having a minimum finish time by comparing the finish times of the stored packets to each other; and
a step of outputting scheduled packets through an output port.
